(19) United States
(12) Patent Application Publication
(10) Pub. No.: US 2023/0290349 A1
(43) Pub. Date: Sep. 14, 2023

(54) VOICE CONTROLLED STUDIO APPARATUS

(71) Applicant: Videndum Plc, Richmond (GB)

(72) Inventors: Philip Christopher Dalgoutte, Bury St. Edmunds (GB); David John Innes, Bury St. Edmunds (GB); Keith David Beacham, Saxmundham (GB)

(21) Appl. No.: 18/041,301

(22) PCT Filed: Aug. 12, 2021
(86) PCT No.: PCT/GB2021/052100

§ 371 Date: Feb. 10, 2023

(30) Foreign Application Priority Data
Aug. 13, 2020 (GB) 2012619.9

(51) Int. Cl. G10L 15/22; H04N 5/222

(52) U.S. Cl. CPC G10L 15/22; H04N 5/2222; G10L 2015/223

(57) ABSTRACT

A voice controlled studio apparatus comprising a presenter interface unit and a producer interface unit, the presenter interface unit and the producer interface unit each adapted to generate commands and each unit comprising a voice input device, the apparatus further comprising a data processing unit adapted to receive commands from the presenter interface and the producer interface, process the commands, parse them to ascertain whether the actions meet at least one pre-determined criterion and then subsequently effect one or more actions based on the commands and the or each pre-determined criterion, and wherein the data processing unit is adapted to prioritise the effecting of actions so that commands generated by the producer interface unit can override the effecting of commands generated by the presenter interface unit, the apparatus further comprising a teleprompt unit adapted to provide a display adapted to be visible by a presenter and adapted to receive actions from a data processing unit and vary the display according to the said actions.

### FIELD OF THE INVENTION

The present inventive concept relates to the field of studio apparatus, such as used in television broadcasting.

### BACKGROUND TO THE INVENTIVE CONCEPT

Ever since the advent of broadcast television, live broadcasts have been challenging because of the aspiration of a flawless programme output, given the inherent limitations of real time production. For example, in a live news broadcast (whether from a studio or on location) a presenter must aim not to make mistakes in reading a script (for example) while also maintaining a steady pace. Furthermore, in today's fast-moving news environment where newsworthy events may happen during a news report—or indeed the instant news story may be updated while a presenter is reading the relevant report—it is important for the script to be changed at very short notice while maintaining the production values and professionalism of the broadcast.

Teleprompts are a known technology in general terms. Teleprompters provide a scrolling text display for a presenter to read from.

In general, teleprompters built for live broadcasts such as in news studios include a network connection to a remote newsroom, enabling real-time updates to the script to be downloaded and displayed to the presenter during a program.

Often the quickly changing news environment requires constant changes to the structure of the live broadcast in order to accommodate breaking news or updates, and this is managed by the producer. A producer of a live broadcast programme thus often has competing calls on their time, in that presenters, cameras, external video feeds, teleprompt devices and other systems must be co-ordinated in real time to deliver the broadcast.

Generally live studios utilise a human teleprompt operator to manually maintain the correct scrolling of the script for the presenter and manage directions embedded in the script from the newsroom. The human operator will also make changes to the teleprompt in real time in response to directions from the producer.

Previous systems have addressed individual issues. For example US 2016062970 provides an teleprompt system which uses a speech recogniser to track the progress of a presenter through a preset script. The system described in that document is a single device operated by an individual who is both prompting operator, presenter and producer. In operation the system does not communicate with any other systems such as a newsroom.

A known system marketed by Autoscript Limited under the brand name “Voiceplus” ™ interprets a phoneme rate of speech of a presenter and uses that interpretation to vary the speed at which text is presented on the teleprompter.

The cited previous systems have drawbacks in that neither enables a producer to interact with the teleprompt. Thus, generally a producer only interacts with a teleprompt by human to human communication from the producer to the teleprompt operator, who in turn controls the teleprompt.

GB-A-2345183 of Canon Research Centre in Europe, EP-A-0896467 of British Broadcasting Corporation and US-A-2020/0051302 of Adobe were cited in the search report of the UK application corresponding to this application. US-A-2020/0051302 is believed by the inventors to be the most relevant document to the present inventive concept.

### SUMMARY OF INVENTION

The present inventive concept provides a voice controlled studio apparatus comprising a presenter interface unit and a producer interface unit, the presenter interface unit and the producer interface unit each adapted to generate commands and each unit comprising a voice input device, the apparatus further comprising a data processing unit adapted to receive commands from the presenter interface and the producer interface, process the commands, parse them to ascertain whether the actions meet at least one pre-determined criterion and then subsequently effect one or more actions based on the commands and the or each pre-determined criterion, and wherein the data processing unit is adapted to prioritise the effecting of actions so that commands generated by the producer interface unit can override the effecting of commands generated by the presenter interface unit, the apparatus further comprising a teleprompt unit adapted to provide a display adapted to be visible by a presenter and adapted to receive actions from a data processing unit and vary the display according to the said actions.

Thus the producer has more direct control of the teleprompt output, so that they can manage the performance of the presenters more effectively. This overcomes a difficulty compared to using a separate human teleprompt operator and also overcomes the difficulty that the producer does not have the capacity to manually scroll the teleprompt themselves.

The said override can effect a delay of any contemporaneous command generated by the presenter interface unit until after a command generated by the producer interface unit. Once the contemporaneous producer interface unit generated command or commands have been completed, the presenter interface unit generated command or commands can be effected.

Alternatively, the override can be adapted to disregard a presenter interface unit generated command which is contemporaneous with a producer interface unit generated command.

The producer interface may further comprise a physical input device. Thus commands may be generated by the producer interface in response to voice activity or physical activity. Preferably the physical input device has simplified controls. Preferably the producer interface has an audio input and a screen input. The screen input preferably has simplified controls. In other words the screen input is much simpler than a typical prompting operator's screen input and displays only the information which the producer may need to direct the prompting activity during a broadcast.

The producer interface may be adapted to be configurable. Thus elements of the producer interface can be tailored to each studio, or even to each producer or show, so that the interface is as simple and intuitive as possible. In the case of the audio input, configuration enables commands, their syntax and their arguments to be defined. In the case of a screen input, configuration allows functions to be enabled and allocated to buttons or sliders, and the positioning and sizing of screen items to be defined.

The presenter interface may be adapted to be configurable. Thus elements of the presenter interface can be tailored to each presenter, so that the interface is as simple and intuitive as possible. In the case of the audio input, configuration enables commands, their syntax and their arguments to be defined.

The apparatus may comprise more than one producer input. Thus, the apparatus may allow more than one individual in a producer role to issue commands. The producer interface may comprise a specific voice input associated with a particular producer input. Thus, commands can be effected according to the specific producer's configuration. This includes configuration of the speech recogniser and parameters to tune the behaviour of the producer interface.

The presenter interface may comprise a specific voice input associated with a particular presenter. Thus, commands can be effected according to the specific presenter's configuration. This includes configuration of the speech recogniser and parameters to tune the behaviour of the presenter interface.

Preferably the apparatus is adapted to be used in a combined automated and human mode, where the automated system provides the primary prompting control; and a human operator supervises the automated system, monitoring its performance and taking over if required in a seamless manner, and preferably also able to hand back to the automated system at any point. Such an arrangement can be used to provide training and help troubleshoot any problems which might arise. In such a mode, the human operator may override commands generated by either or both of the producer interface unit(s) and the presenter interface unit.

Preferably the apparatus is adapted to receive voice inputs in more than one spoken language.

Preferably the apparatus is adapted to recognise voice inputs comprising proper nouns, such as personal and/or place names.

Preferably the apparatus is adapted to distinguish between voice inputs which comprise commands to be actioned and voice inputs which are not intended to result in actions.

Preferably the apparatus is adapted to comprise a database comprising voice inputs which comprise commands to be actioned. Preferably the database further comprises a representation of a script to be spoken by a presenter, the representation including markers adapted to identify particular aspects of the script. Markers may be provided such as to denote whether particular words are expected to be spoken by the presenter or not spoken by the presenter, if words are not expected to be pronounced phonetically, and the like. Thus, the apparatus can be adapted to differentiate between voice inputs which are commands to be actioned and which are part of a script. For example the apparatus should accept different accents or pronunciations of words.

Thus, furthermore, the apparatus can be adapted to track progress of the presenter through the script. For example, the script should start scrolling on the display soon after the presenter has started to read the script, yet it must not scroll if the presenter is ad-libbing rather than following the script. It should smoothly scroll to keep the current reading position in a constant position on the prompting screen. Small deviations of a fraction of a line are acceptable but there should be no jittering or jumping. The script should stop scrolling quickly after the presenter stops speaking or is not following the script.

Thus, yet further, the apparatus can be adapted to identify commands to be actioned within a wider spoken speech pattern. For example, the apparatus should continue to operate reliably if there are misspellings in the script, or if the presenter makes minor changes to the script as they read.

The present inventive concept thus includes an automated prompting system which not only has an audio input from the presenter, but also has an input from a producer to direct the scrolling of the script and aspects of the prompting system. Commands which can be input to the system include:
Loading a preset configuration of the prompting system, for example to set it up for a specific show. This configuration can include newsroom configuration, presenter configuration, and system configuration (the connection and configuration of prompting screens and scroll controllers).
Loading specific scripts from a newsroom system.
Navigating within a script, such as jumping to specified stories or events. This is often used by the producer in a news broadcast to manage the content and sequence of stories to fit within a fixed timeslot when the news is dynamically changing during the broadcast.
Turning prompting on or off.
Modifying the current scrolling rate, such as “stop scrolling, start scrolling, speed up, slow down”. These commands enable the producer to specifically direct the presenter to start or stop reading, or to speed up or slow down their delivery in response to the changes invoked on the teleprompting system.
Changing the configuration of the prompting display to assist the presenter, such as changing the font size or colour, the background colour, or the position marker.
Re-direction of the prompting system if the presenter interface unit has been unable to keep track of the presenter position, such as when they have deviated significantly from the script. This can be achieved with commands such as “next story” or jumping to a specific story or point in the script.

Through the producer interface unit, the producer controls the prompting system to quickly react to the real-time changes happening during the broadcast. The combination of the producer interface unit and the presenter interface unit also enables the prompting system to operate autonomously within a studio environment.

As mentioned, during the broadcast of a show, the producer is an extremely busy individual as they are directing all aspects of the show, for which the prompting is only one part. The producer input to the prompting system must therefore be very simple and quick to use.

This inventive concept provides an interface to the prompting system which is specifically adapted to the needs of the producer—as described above.

Preferably the producer interface includes both an audio interface and a screen interface. Preferably the audio interface enables the producer to speak commands to the prompting system in the same way that they would speak commands over the studio intercom to one of the other humans in the studio control room and so minimises the changes to their existing operating methods.

A screen input may be preferred by some producers and can also be provided as a backup for if there are any issues with the audio input. The producer's screen input is much simpler than a typical prompting operator's screen input—displaying only that information which the producer needs to direct the prompting system and its operation during the show.

Preferably both the screen input and the producer interface audio input can be tailored to each studio, or even to each producer or show, so that the interface is as simple and intuitive to a user as possible. In the case of the audio input, configuration enables commands, their syntax and their arguments to be defined. In the case of the screen input, configuration allows functions to be selected and allocated to buttons or sliders, and the display, positioning and sizing of screen items to be defined.

Preferably the prompting system can be used in a combined automated and human mode, where the automated system provides a primary prompting control; and a human operator can supervise the automated system, monitoring its performance and taking over if required in a seamless manner, and hand back to the automated system at any point. Such an arrangement is particularly advantageous during the introduction of an automated prompting system into a previously human operated environment, and also for training and to help troubleshoot any problems which might arise.

Optionally the prompting system will accommodate multiple producer inputs, as the producer function may be spread across more than one individual in the studio control gallery.

The data processing unit may comprise a configuration manager. The data processing unit may comprise a command manager. The data processing unit may comprise a scroll engine. The data processing unit may comprise a newsroom interface. The data processing unit may comprise a text editor. The data processing unit may comprise a scroll controller. The data processing unit may comprise a device manager.

The configuration manager may be adapted to display information relating to the configuration of system components and to enable a user to modify them.

The command manager may be adapted to act as a common entry point for all the actions that can be taken in the data processing unit. The command manager may be adapted to distribute actions to relevant components of the apparatus.

The scroll engine may be adapted to display text on the display and to scroll the text and manage the scrolling of the text.

The newsroom interface may be adapted to download a run order from a data storage means and to synchronise text in the scroll engine with any updates from a newsroom. Such a newsroom may be part of the studio or in communication therewith.

The text editor may be adapted to enable a user to modify text.

The scroll controller may be adapted to be a display-based scroll controller which can be operated by keyboard and mouse. The scroll controller is generally used as a backup by a prompt operator.

The device manager may be adapted to manage connections and status reporting with other elements of the apparatus. For example the display or the scroll controller.

The apparatus may further comprise a preview monitor adapted to substantially replicate what is displayed on the prompter screen to the presenter.

Further features and combinations of features of the inventive concept will now be described with reference to the accompanying drawings.

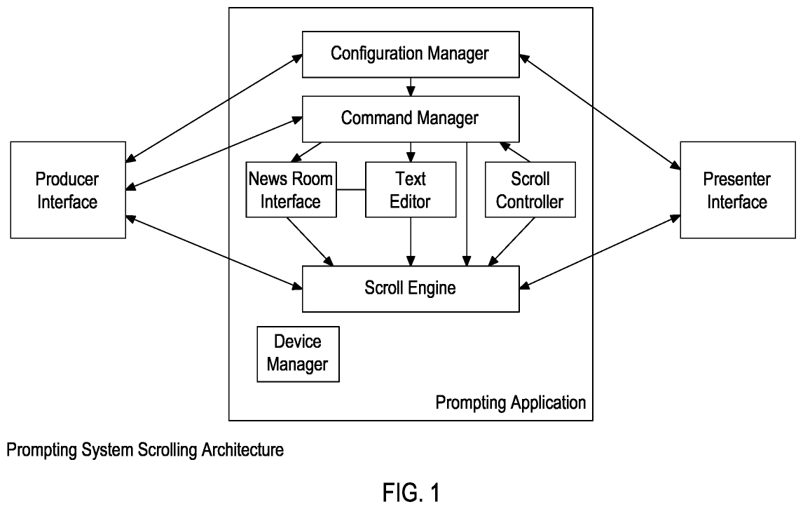

As shown in FIG. 1, the producer interface unit and the presenter interface unit communicate with several of the prompting system functions. A key interface is that to the scroll engine which controls the display of text on the prompter display: including the size and colour of the text and its scrolling.

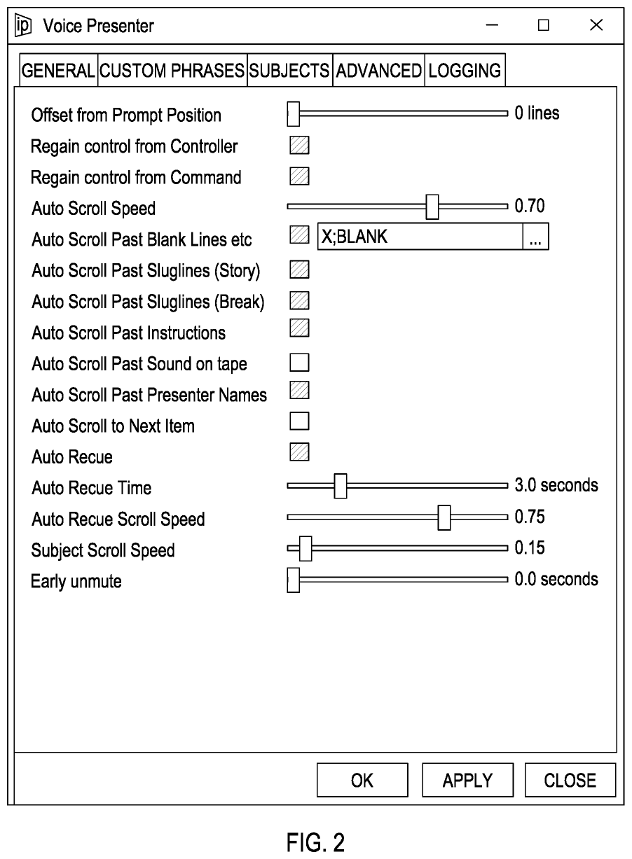

In addition to the scroll engine, the presenter interface unit communicates with the configuration manager to enable the configuration of the presenter interface unit. This includes configuration of the speech recogniser and parameters to tune the behaviour of the presenter interface (see also FIG. 2). The configuration of the presenter interface unit could be performed via a screen interface to the presenter interface unit, but it is simpler for the user if these parameters are included within a configuration interface of the system.

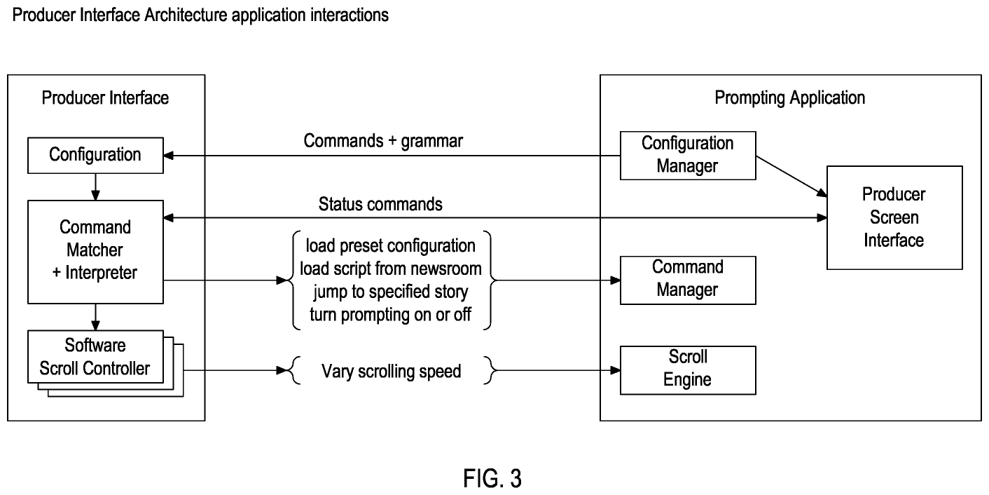

The producer interface unit communicates with several of the system components, not only to enable the configuration of the producer interface unit but also to modify the configuration and operation of the system in response to commands, from the producer for example. This is simplified if the system is structured with a common command manager which handles all actions such as loading new run-orders or jumping to different stories. This is shown in more detail in FIG. 3.

The scroll engine is designed such that the presenter interface unit, the producer interface unit and manual scroll controllers may co-exist. This is advantageous in an automated prompting system as the presenter interface unit may be controlling the scroll speed but can be interrupted by the producer interface unit or a manual scroll controller operated by a human operator, and can then pick up scroll control again after the intervention.

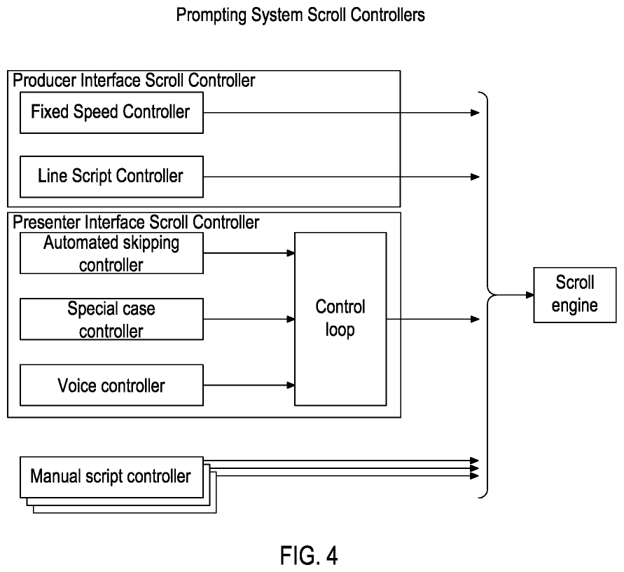

The overall scroll engine system architecture is shown in FIG. 4, which shows that in addition to manual scroll controllers, there are a number of software-based scroll controllers, some part of the producer interface unit and some part of the presenter interface unit, and each of which performs a particular automated scrolling function.

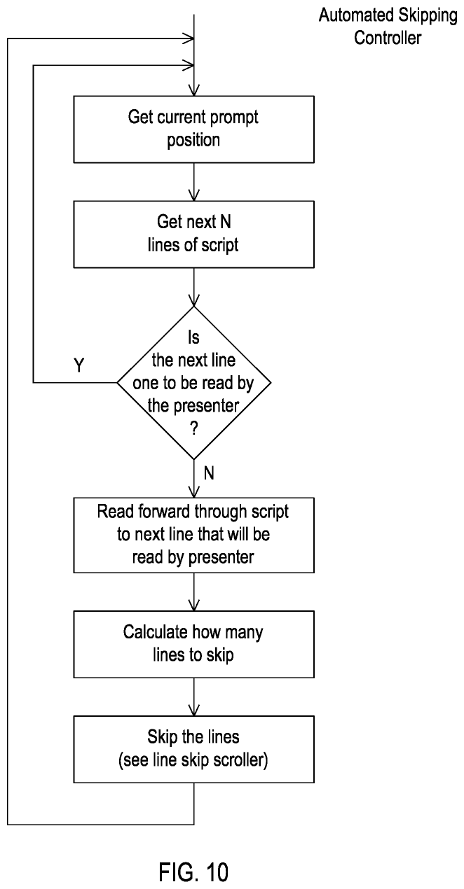

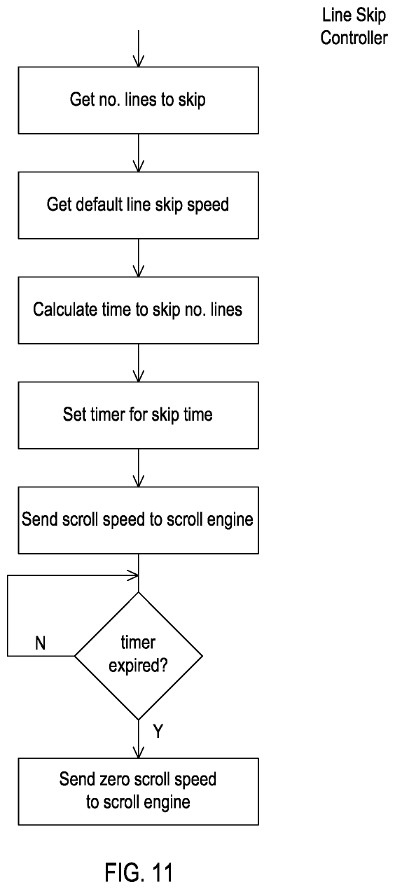

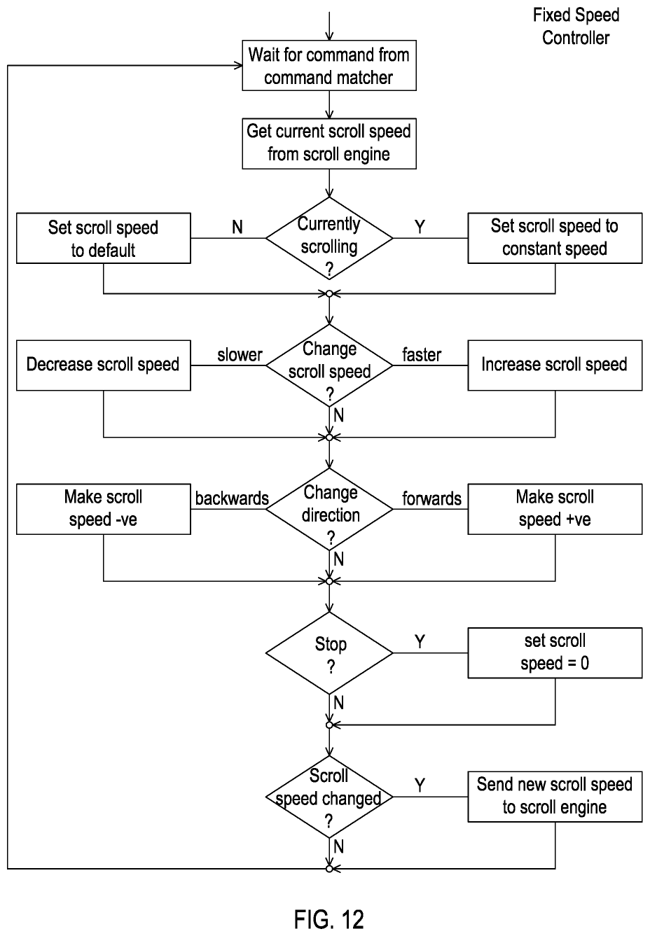

Each software-based scroll controller performs a specific function:
Fixed speed controller—calculates and requests a single scroll speed. Until there are any further controller commands, the scroll engine will continue to scroll the text at this speed. This controller is part of the producer interface unit and implements the Producer commands of “forwards”, “backwards”, “faster”, “slower” and “stop”.
Line Skip controller (shown in further detail in FIG. 11)— calculates and requests a scroll speed, then after a calculated time requests that the scrolling stops. This controller is part of the producer interface unit and used to implement producer commands of “skip” to scroll over a number of lines or a specific block in the script.
Voice controller—sends a stream of requests of scroll speeds to maintain the correct place in the script with respect to what the presenter is speaking. This controller is the core of the presenter interface unit and implements the automated tracking of the presenter relative to the script.
Automated skipping controller (shown in further detail in FIG. 10)— identifies that the presenter has reached a block of text in the script which should be ignored, such as embedded directions, and skips over the block to the next section of script which the presenter will read. This controller is similar to the line skip controller described before but is operating continuously as part of the presenter interface unit.
Special case controller—additional controllers can be designed and added to meet specific studio workflow requirements, such as scrolling at a fixed speed over certain types of block in the script which the presenter needs to see (e.g. special directions or messages) but which they do not read out.

It is worth noting that that scroll navigation commands, such as “Next story”, “previous story” are sent to the command manager in the system, which then actions them with the scroll engine. These commands may originate from the producer interface unit or may be tied to specific buttons on the manual scroll controllers.

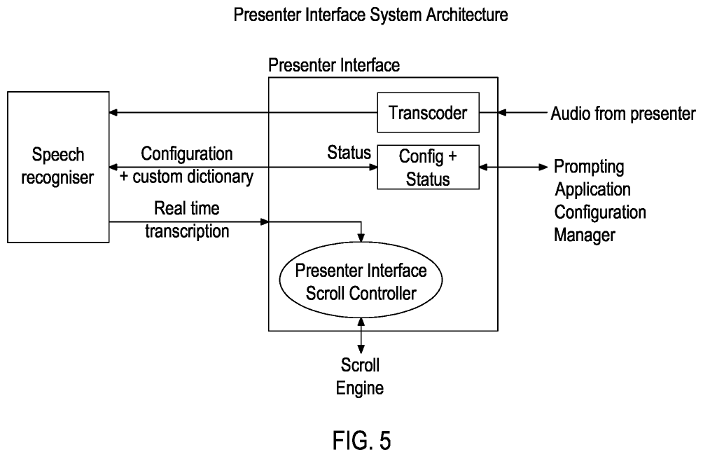

The overall presenter interface unit architecture is shown in FIG. 5.

In use:
A transcoder manages the audio input from the presenter and converts it to the correct format for the speech recogniser.
A configuration and status module manages the configuration of the presenter interface unit.
A number of presenter interface unit scroll controllers control the scroll speed in response to the transcription coming from the speech recogniser. A key software scroll controller is the voice controller which implements the control of scroll speed to match the prompter output to the presenter's audio.

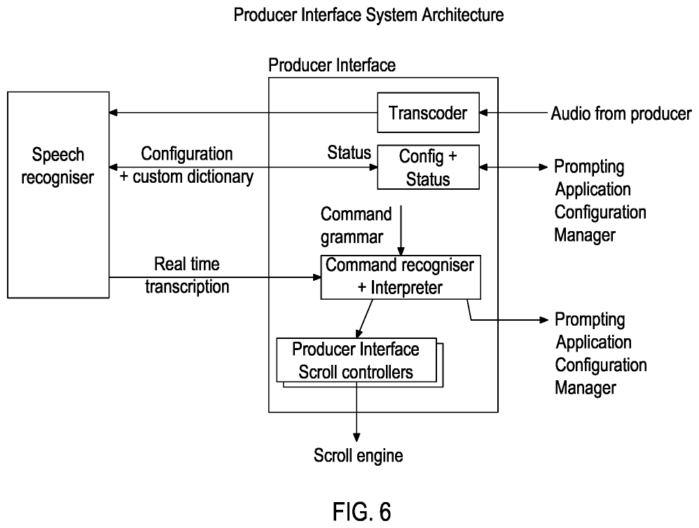

The overall Producer Interface architecture is shown in FIG. 6.

In use:
A transcoder manages the audio input from the producer and converts it to the correct format for the speech recogniser.
A configuration and status module manages the configuration of the producer interface unit. This is a key component as the producer interface unit is highly configurable to match the voice commands or screen display to the preferences of the producer.
A command matcher and interpreter module analyses the real time transcription coming back from the recogniser and matches it to one of the pre-defined commands. Techniques similar to that used in the presenter interface unit script matcher can be used to achieve this.
Producer interface unit scroll controllers control the scroll speed in response to particular commands recognised by the command matcher, such as “speed up”, “slow down” and “skip lines”.

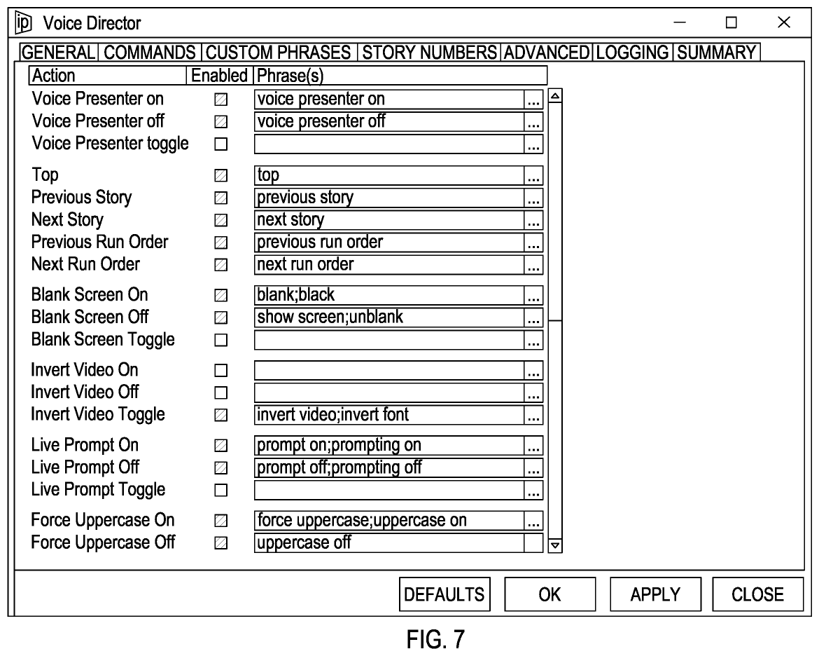

Each producer will likely have preferred phrases and workflows within their shows, and so the producer interface unit commands are designed to be flexible enough to accommodate this. This can be achieved by providing means adapted to enable or disable each possible action, and to define one or more phrases to trigger each action. Multiple phrases can be associated with the same action. An example of this configuration is shown in FIG. 7.

In FIG. 7 for example, the action “live prompt on” has been enabled and may be triggered by the producer saying either “prompt on” or “prompting on”.

The configuration screens are displayed by the system configuration manager, and the configuration module in the producer interface unit uses the data to construct valid strings that the command matcher can match against. It also can generate a custom dictionary for the speech recogniser to maximise the recognition performance for the configured phrases.

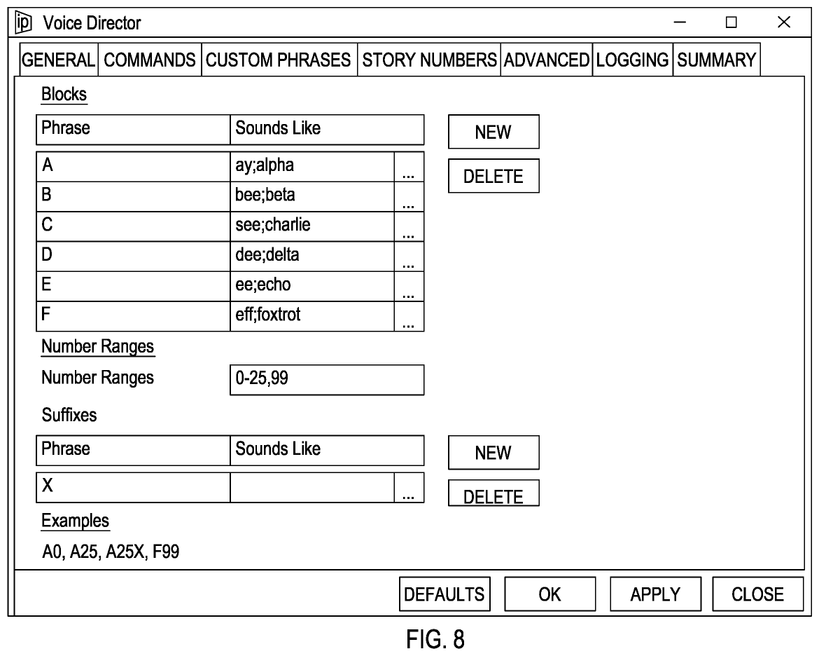

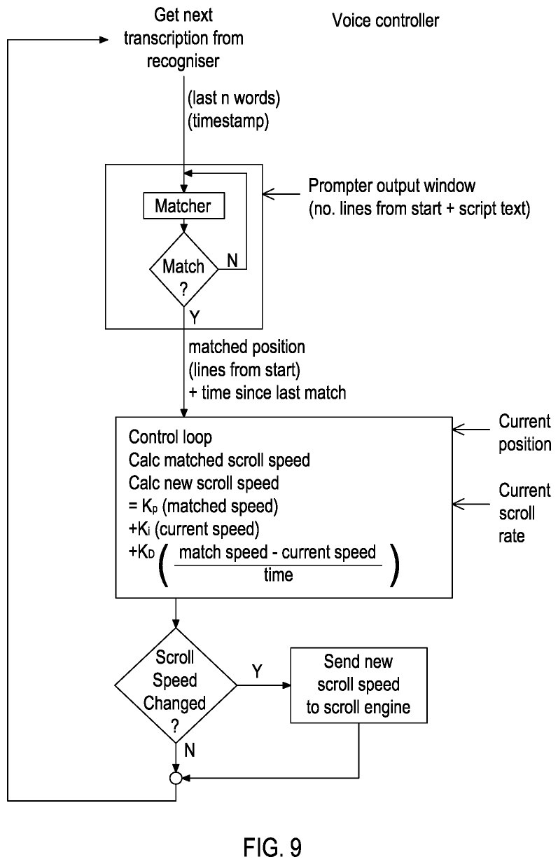

Another example of the configuration is shown in FIG. 8, which shows how valid story numbers can be defined to enable the producer to tell the system to jump to a specific story. Shown in the example story numbers starting with the letter A to F are valid, and numbers between 0 and 25 or the number 99 are valid. A suffix of “X” is also valid. The producer may say “jump to A25” or they may use the phonetic alphabet and say “jump to Alpha 25”.

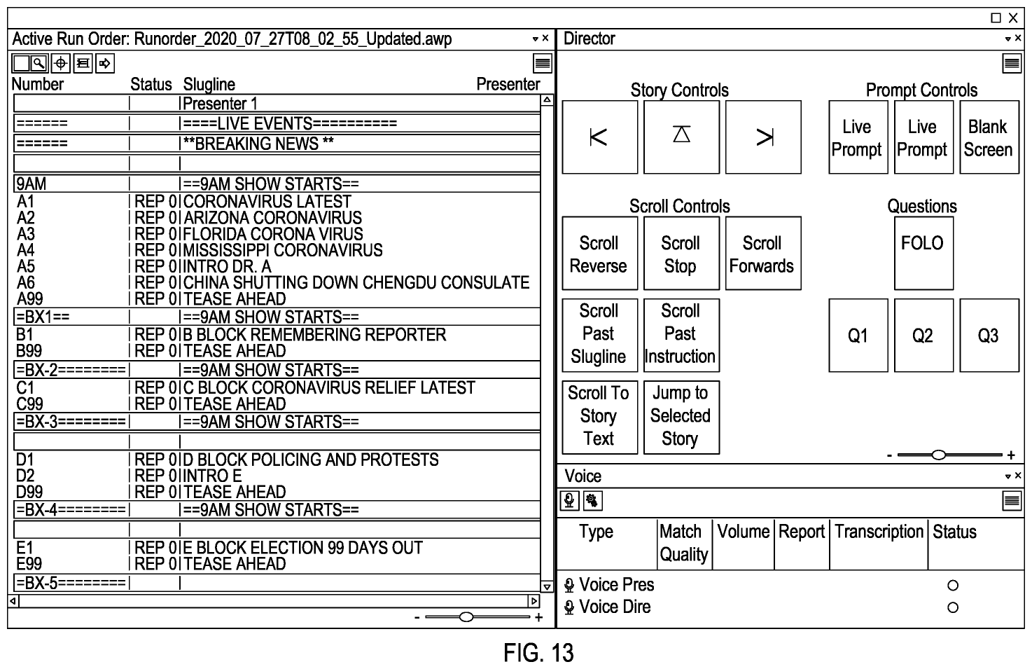

An example producer screen input is shown in FIG. 13.

This screen exemplified in FIG. 13 is displaying the current run order of stories as delivered in real time by the newsroom on the left hand side, and the story in that run order which is currently being prompted to the presenter will be highlighted. The producer can jump to any other story by touching that story with their finger or pointing with a mouse. On the right hand side is a set of buttons which implement specific commands. At the bottom of the right hand side is a window showing the status of the producer and presenter voice interfaces. The contents of the screen and their positioning and the number, size, position, function and labelling of the buttons is configurable.

1. A voice controlled studio apparatus comprising a presenter interface unit and a producer interface unit, the presenter interface unit and the producer interface unit each adapted to generate commands and each unit comprising a voice input device having a speech recogniser, the apparatus further comprising a data processing unit adapted to receive commands from the presenter interface and the producer interface, process the commands, parse them to ascertain whether the commands meet at least one pre-determined criterion and then subsequently effect one or more actions based on the commands and each pre-determined criterion, and wherein the data processing unit is adapted to prioritise the effecting of actions so that commands generated by the producer interface unit can override the effecting of commands generated by the presenter interface unit, the apparatus further comprising a teleprompt unit adapted to provide a display adapted to be visible by a presenter and adapted to receive actions from a data processing unit and vary the display according to the said actions, and wherein the apparatus further comprises a transcoder adapted to manage the audio input from the producer and to convert it to a correct format for the speech recogniser, a configuration and status module adapted to configure the producer interface, and a command matcher and interpreter module adapted to analyse the real time transcription from the speech recogniser, commands being selected from a group including one or more of: loading a preset configuration of the apparatus, loading specific scripts from a newsroom system, navigating within a script, turning prompting on or off, modifying the current scrolling rate, changing the configuration of the prompting display to assist the presenter, re-direction of the prompting system if the presenter interface unit has been unable to keep track of the presenter position.

2. A voice controlled studio apparatus according to claim 1, further comprising a physical input device.

3. A voice controlled studio apparatus according to claim 1, wherein the producer interface has an audio input and a screen input.

4. A voice controlled studio apparatus according to claim 1, comprising more than one producer interface.

5. A voice controlled studio apparatus according to claim 1, wherein the apparatus is adapted to be used in a combined automated and human mode, where the automated system provides the primary prompting control; and a human operator supervises the automated system, monitoring its performance and taking over if required in a seamless manner, and also able to hand back to the automated system at any point, the human operator being independent of both the presenter interface and the producer interface.

6. A voice controlled studio apparatus according to claim 1, wherein the apparatus is adapted to receive voice inputs in more than one spoken language.

7. A voice controlled studio apparatus according to claim 1, wherein the apparatus is adapted to recognise voice inputs comprising proper nouns, such as personal and/or place names.

8. A voice controlled studio apparatus according to claim 1, wherein the apparatus is adapted to distinguish between voice inputs which comprise commands to be actioned and voice inputs which are not intended to result in actions.

9. A voice controlled studio apparatus according to claim 1, wherein the apparatus is adapted to comprise a database comprising voice inputs which comprise commands to be actioned.

10. A voice controlled studio apparatus according to claim 9, wherein the database further comprises a representation of a script to be spoken by a presenter, the representation including markers adapted to identify particular aspects of the script.

11. A voice controlled studio apparatus according to claim 10, wherein said markers are provided such as to denote whether particular words are expected to be spoken by the presenter or not spoken by the presenter, if words are not expected to be pronounced phonetically, and the like.
